(19) United States
(12) Patent Application Publication
(10) Pub. No.: US 2026/0059256 A1
(43) Pub. Date: Feb. 26, 2026

(54) METHOD OF CONTROLLING DIRECTIONAL SOUND PICKUP IN CROSS-VIEW CONFERENCE MEETINGS

(71) Applicant: Cisco Technology, Inc., San Jose, CA (US)

(72) Inventor: Bjørn Winsvold, Tranby (NO)

(21) Appl. No.: 18/809,512

(22) Filed: Aug. 20, 2024

(51) Int. Cl. H04S 7/00

(52) U.S. Cl. CPC H04S 7/303; H04S 2400/01; H04S 2400/11

(57) ABSTRACT

A method performed by a conference system having video cameras positioned around a room to capture views of areas of the room, the method comprising: receiving directional audio from directional microphones positioned adjacent to the areas and configured to form directional beams to receive the directional audio from the areas; detecting an active talker in an area based on the directional audio; capturing a view of the area with a video camera; detecting one or more heads across the view; positionally classifying the directional audio received by the directional beams adjacent to the area to visually match the one or more heads in the view to produce positionally classified audio; coding the positionally classified audio into positional audio channels; and transmitting the view and the positional audio channels.

### TECHNICAL FIELD

The present disclosure relates to controlling conference systems.

### BACKGROUND

A cross-view conference arrangement employs multiple cameras arranged around the sides of a room to capture multiple cross-views of the room that oppose the multiple cameras. When the cross-view conference arrangement further includes directional microphones positioned around the room to capture audio from participants seated in the cross-views, it can be challenging to assign audio received from participants occupying the cross-views to directional audio, such as stereo audio.

### BRIEF DESCRIPTION OF THE DRAWINGS

FIG. 1 is an illustration of a conference system for controlling directional audio pickup in cross-view conference meetings, according to an example embodiment.

FIG. 2 is an illustration of a directional microphone used in the conference system, according to an example embodiment.

FIG. 3 is a block diagram of the conference system that shows connectivity between components of the conference system, according to an example embodiment.

FIG. 4 is a flowchart of a method of controlling directional audio pickup in a cross-view conference meeting, performed by the conference system, according to an example embodiment.

FIG. 5 is an illustration of configuring directional audio to visually match a view that frames a single head, according to an example embodiment.

FIG. 6 is an illustration of configuring directional audio to visually match a view that shows left, center, and right heads in the view, according to an example embodiment.

FIG. 7 is an illustration of configuring directional audio received by left, center, and right directional microphones to visually match a view that shows multiple heads across the view, according to an example embodiment.

FIG. 8 is an illustration of configuring directional audio from left and right directional microphones to visually match a view that shows multiple heads across the view, according to an example embodiment.

FIG. 9 is an illustration of configuring directional audio when an expanded view encompasses a right area, a center area, and left area in a room, according to an example embodiment.

FIG. 10 is a block diagram of a controller of the conference system, according to an example embodiment.

FIG. 11 illustrates a hardware block diagram of a computing device that may perform functions presented herein, according to an example embodiment.

### DETAILED DESCRIPTION

### Overview

In an embodiment, a method is performed by a conference system having video cameras positioned around a room to capture views of areas of the room. The method comprises: receiving directional audio from directional microphones positioned adjacent to the areas and configured to form directional beams to receive the directional audio from the areas; detecting an active talker in an area based on the directional audio; capturing a view of the area with a video camera; detecting one or more heads across the view; positionally classifying the directional audio received by the directional beams adjacent to the area to visually match the one or more heads in the view to produce positionally classified audio; coding the positionally classified audio into positional audio channels; and transmitting the view and the positional audio channels.

### Example Embodiments

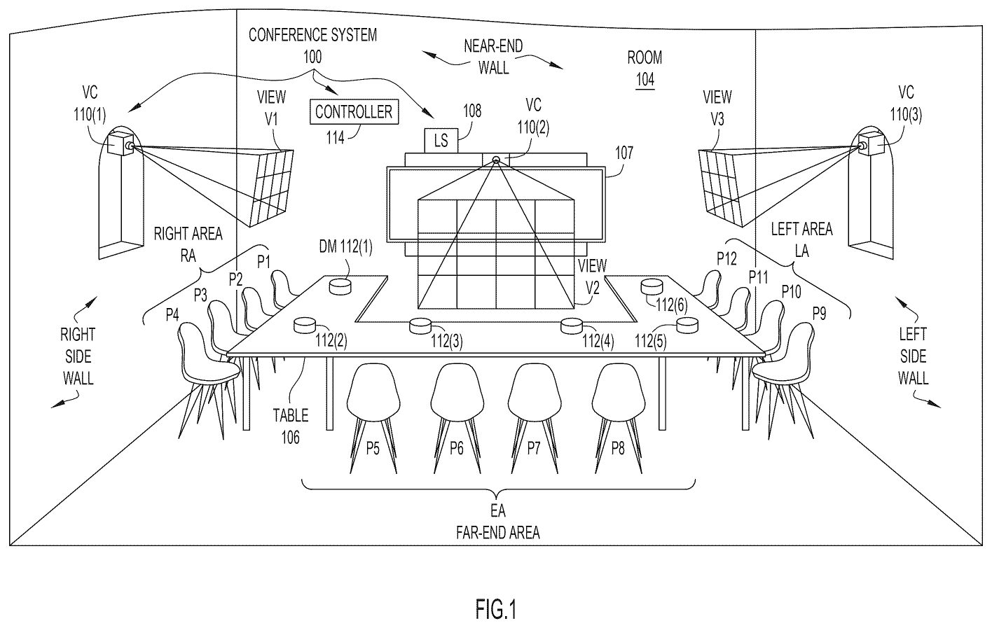

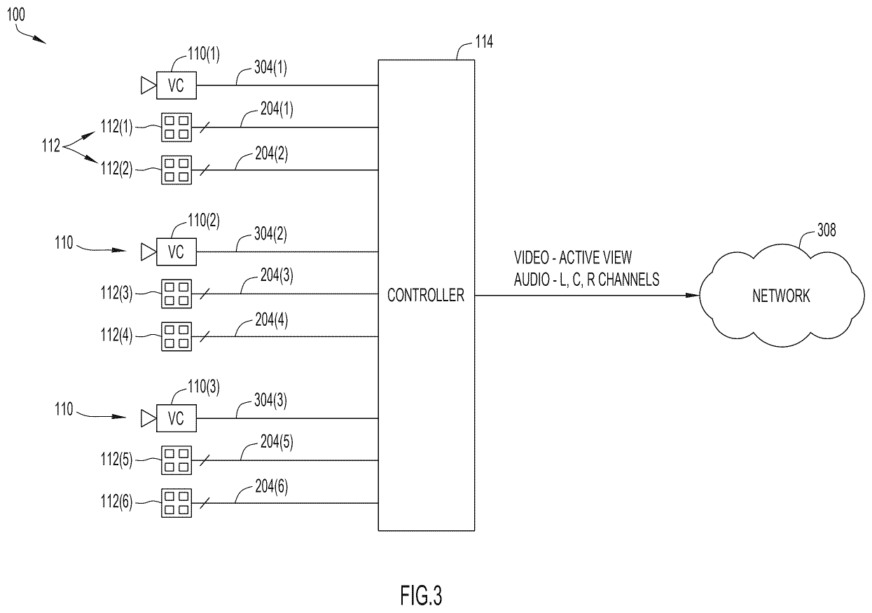

With reference to FIG. 1, there is an illustration of an example conference system 100 for controlling directional sound pickup in a cross-view conference meeting according to embodiments presented herein. In the example of FIG. 1, conference system 100 is deployed in a room 104 (more generally, any physical space) that includes a table 106 (e.g., a U-shaped table) centered in the room and surrounded by chairs in positions P1-P12 for seating participants of a conference meeting (also referred to as a “conference session”). Conference system 100 includes components that are physically distributed around room 104. FIG. 3 described below shows connections between the components.

As shown in FIG. 1, conference system 100 includes a video display 107, a loudspeaker (LS) 108, video cameras (VCs) 110(1), 110(2), and 110(3) (collectively referred to as VCs 110) respectively fixed to right, near-end (e.g., back-end), and left walls of room 104, directional microphones (DMs) 112(1)-112(6) (collectively referred to as DMs 112) resting on table 106, and a controller 114 that communicates with and controls the video display, video cameras, and the directional microphones. In some arrangements, conference system 100 may also include omni-directional microphones. VCs 110(1), 110(2), and 110(3) respectively occupy right, center, and left positions looking away from VC 110(2) toward table 106. VCs 110(1), 110(2), and 110(3) respectively capture video of views V1, V2, and V3 of a left area LA, a far-end (and center) area EA, and a right area RA of room 104 opposite the video cameras. Such views are referred to as “cross-views” captured by the video cameras that are positioned opposite or across from the views. Thus, conference system 100 is deployed in a cross-view arrangement in room 104.

In the example of FIG. 1, DMs 112 include (i) DMs 112(1), 112(2) positioned next to each other on a right side of table 106 adjacent to right area RA, DMs 112(3), 112(4) positioned next to each other on a far side of the table adjacent to far-end area EA, and DMs 112(5), 112(6) positioned next to each on a left side of the table adjacent to left area LA. DM pairs (112(1), 112(2)), (112(3), 112(4)), and (112(5), 112(6)) respectively receive directional audio from positions P1-P4 of right area RA, positions P5-P8 of far-end area EA, and positions P9-P12 of left area LA.

According to embodiments presented herein, conference system 100 captures a view of an area of room 104 that includes one or more heads of participants, and visually matches (e.g., assigns) directional audio captured by DMs 112 from the area to positions of the heads in the view. The embodiments code the directional audio, as matched to the head positions in the view, into audio channels, and transmit the audio channels and the view to a remote endpoint device. At the remote endpoint device, playback of the view along with the audio channels as matched to the heads in the view provides an improved meeting experience for participants to a cross-view conference arrangement.

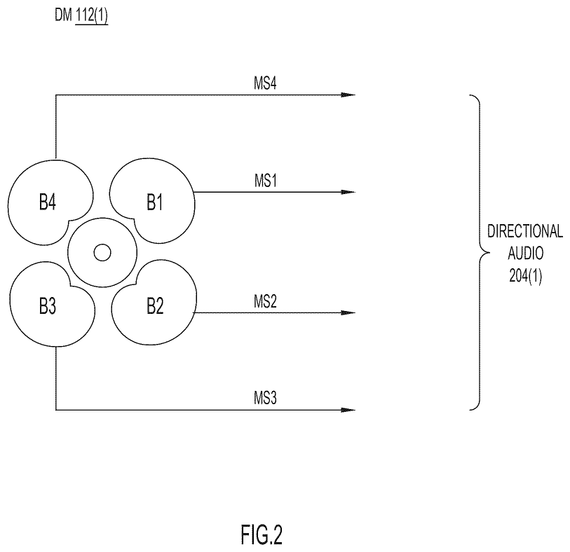

FIG. 2 is an illustration of DM 112(1) according to an embodiment. The example configuration of DM 112(1) is generally representative of the other DMs. DM 112(1) includes directional elements (not shown) that form directional beams B1, B2, B3, and B4 (also referred to as “radiation patterns”). The directional beams/directional elements are sometimes referred to as “channels” of DM 112(1). The directional elements are arranged positionally such that directional beams B1, B2, B3, and B4 are equi-spaced about a periphery of DM 112(1). DM 112(1) receives directional audio via directional beams B1-B4, converts the directional audio as received to microphone signals MS1-MS4 (collectively referred to as microphone signals 204(1)) that convey the directional audio picked-up by corresponding ones of the directional beams, and sends the microphone signals to controller 114. The directional audio picked-up by a directional audio beam (e.g., directional audio beam B1) and the corresponding microphone signal (e.g., microphone signal MS1) have a one-to-one correspondence, and may be referred to equivalently.

As depicted in the example of FIG. 2, DM 112(1) has left and right sides, and directional beam pairs (B3, B4) and (B1, B2) are depicted as emanating from or being positioned on the left and right sides, respectively. Therefore, directional beam pairs (B3, B4) and (B1, B2) generally receive or pickup directional audio arriving from (originating at) areas to the left and right of DM 112(1), respectively. As used herein, a directional beam Bi may be referred to interchangeably with and equivalently to the directional element that forms the directional receive beam Bi.

FIG. 3 is a block diagram of conference system 100 that shows connectivity between components of the conference system, according to an embodiment. VCs 110(1), 110(2), and 110(3) capture video of views of room 104 as described above and provide corresponding video signals 304(1), 304(2), and 304(3) that convey the video of the views to controller 114. DMs 112(1)-112(6) receive directional audio via their directional beams and send the directional audio to controller 114 via sets of microphone signals 204(1)-204(6). Controller 114 receives the video and the directional audio (as conveyed in the microphone signals). Controller 114 communicates with a network 308, which may include one or more wide area networks (WANs), such as the Internet, and one or more local area networks (LANs).

Controller 114 controls VCs 110 and DMs 112, and processes the video received from the VCs and the directional audio (i.e., the microphone signals) received from the DMs according to embodiments presented herein. Under control of controller 114, conference system 100 may join and participate in an online conference session with one or more remote endpoint devices connected to network 308. During the conference session, controller 114 sends video and audio to the remote endpoint devices over network 308. For example, controller 114 may send audio that includes left audio (L), center audio (C), and right audio (R) channels, and video that includes an active view, as described below.

Controller 114 stores predetermined information that maps distinct identities of VCs 110, DMs 112, and positions P1-P12 to corresponding positions (e.g., 3D coordinate positions) in room 104. The predetermined information also defines a predetermined positional arrangement of directional beams B1-B4 (and corresponding directional elements) of each DM 110(i) relative to an area of room 104 (e.g., relative to positions P1-P12) to which each DM is adjacent. The predetermined positional arrangement defines which directional beams/directional elements of which DMs receive energy from which areas of room 104, and also a left vs. right designation of the directional beams relative to each other. An example predetermined positional arrangement may include the following.

DM 110(1) BMs 3, 4 and DM 110(2) BMs 3, 4 all face (i.e., are adjacent to and receive directional audio from) right arca RA. Facing right area RA, DM 110(1) BMs 3, 4 are to the right of DM 110(2) BMs 3, 4. DM 110(1) BM 4 is a rightmost beam, DM 110(2) BM 3 is a leftmost beam. BMs 1, 2 face away from right area RA. The aforementioned positional directional beam assignments relative to right area RA hold for a view of the right area. DM 110(3) BMs 2, 3 and DM 110(4) BMs 2, 3 all face (i.e., receive directional audio from) far-end area EA. Facing far-end area EA, DM 110(3) BMs 2, 3 are to the right of DM 110(4) BMs 2, 3. DM 110(3) BM 3 is a rightmost beam, DM 110(4) BM 2 is a leftmost beam. BMs 1, 4 face away from far-end area EA. The aforementioned positional directional beam assignments relative to far-end area EA hold for a view of the far-end area.

DM 110(5) BMs 1, 2 and DM 110(6) BMs 1, 2 all face (i.e., receive directional audio from) left area LA. Facing LA, DM 110(5) BMs 1, 2 are to the right of DM 110(6) BMs 1, 2. DM 110(5) BM 2 is a rightmost beam, DM 110(4) BM 1 is a leftmost beam. BMs 3, 4 face away from left area LA. The aforementioned positional directional beam assignments relative to left area LA hold for a view of the left area. Other predetermined positional arrangements are possible.

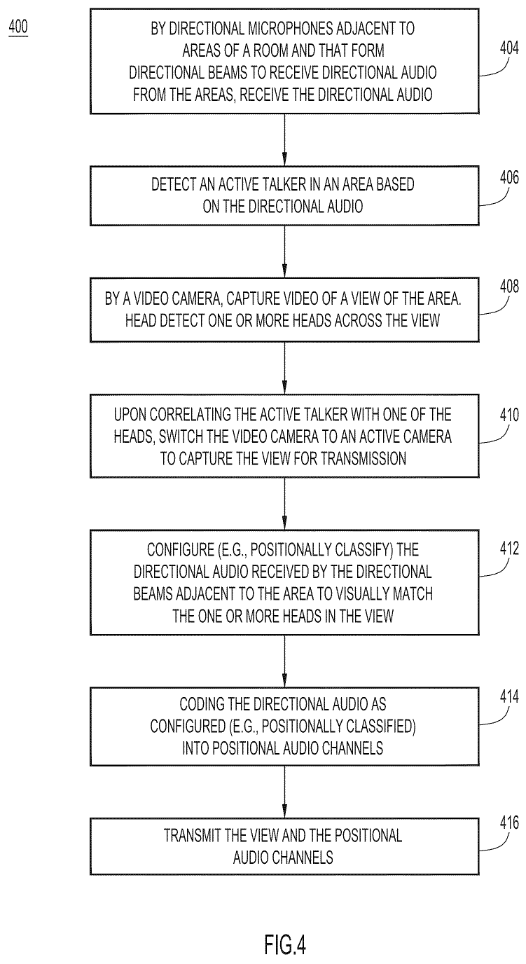

FIG. 4 is a flowchart of an example method 400 of controlling directional audio pickup in a cross-view conference meeting, performed by conference system 100. Method 400 may be performed while conference system 100 participates in a conference meeting with remote endpoint devices over network 308. As mentioned above, conference system 100 includes VCs 110 positioned around room 104 to capture views (i.e., cross-views) of areas of the room opposing the video cameras.

At 404, DMs 112 positioned adjacent to areas RA, EA, and LA receive directional audio from each area via directional beams, and provide to controller 114 microphone signals that convey the directional audio. As mentioned above, the directional audio and the microphone signals have a one-to-one correspondence.

At 406, controller 114 detects an active talker and a talker position of the active talker in any of positions P1-P4 of right area RA, positions P5-P8 of far-end area EA, or positions P9-P12 of left area LA based on the directional audio (i.e., microphone signals). That is, controller 114 detects the active talker in one of areas RA, EA, and LA. Controller 114 may employ any known or hereafter developed audio detection techniques to detect the presence of the active talker and the talker position, such as audio triangulation. In addition, using artificial intelligence (AI) or machine learning (ML) techniques, controller 114 may construct an audio heat map of active talkers that further indicates the presence and positions of the active talkers. In some examples, controller 114 may detect active talkers in multiple ones of areas RA, EA, and LA.

At 408, controller 114 performs head detection (also referred to as “head-detecting” or “detecting heads”) on views captured by VCs 110 to (i) detect one or more heads of participants in the views, (ii) determine positions of the one or more heads in the views, and (iii) determine a head/face orientation (i.e., head pose) for each detected head. An orientation of a head represents a direction in which the head is facing or looking. Controller 114 may employ any known or hereafter developed head detection algorithm to detect the heads and their orientations. The head detection may detect a single head or multiple heads across each view. Controller 114 may partition or segment a view into left and right sections of the view, or into left, center, and right sections of the view. Controller 114 may identify which of the sections of the view include heads, e.g., whether the left, center, and/or right sections include heads (e.g., left, center, and/or right heads). Such view segmentation aids in positionally matching the directional audio beams to the heads in the view, as described below.

At 410, controller 114 performs active talker-to-head correlations. The active talker-to-head correlations (i) positionally correlate active talkers from 406 to heads from 408 (to ensure each active talker coincides with a head), and (ii) determine which head is facing which cross-view (i.e., opposing) VC among VCs 110, if any. Upon detecting/determining that the active talker from 406 is positively correlated to a head facing a cross-view VC (i.e., an opposing VC) among VCs 110, controller 114 switches the cross-view VC to an active camera to capture video of the view of the area in which the active talker is positioned, for subsequent transmission of the view. For example, upon detecting that the active talker in position P2 of right area RA is facing cross-view/opposing VC 110(3), controller 114 switches VC 110(3) to the active camera, to capture view V3 of the area with the active talker. The view may include other participants in addition to the active talker.

At 412, controller 114 configures directional audio received from the area by the directional beams adjacent to the area to visually match the positions of the one or more heads in the view of the area. To do this, controller 114 positionally classifies the directional beams adjacent to the area, which correspondingly positionally classifies the directional audio received by the directional beams, (e.g., as right, center, and/or left audio) to visually/positionally match the positions of the one or more heads in the view of the area. Positionally classifying the directional audio produces positionally classified audio. Positional classifying the directional audio may result in assigning positional labels (e.g., left, right, and so on) to microphone signals that convey the positional audio. The visually matching at 412 may be performed based on the view and knowledge of the positional arrangement of directional beams, and without using the audio detection employed at 406 and without using the talker position information derived from the audio detection.

At 414, controller 114 codes the positionally classified directional audio into matching positional audio channels (e.g., right, center, and/or left audio channels) to produce positional audio channels.

At 416, controller 114 transmits the video of the view and the positional audio channels to the remote endpoint devices over network 308.

Various examples of configuring (e.g., positionally classifying) directional audio to visually match heads as seen in views are described below in connection with FIGS. 5-9. FIGS. 5-9 depict a directional beam Bi/directional element Pi of a DM as a circle that contains a designator R, C, L, or O to indicate that the directional beam is configured (e.g., positionally classified) as right audio (R), center audio (C), left audio (L), or turned off (O) (i.e., ignored by controller 114). It is understood that configuring a directional beam Bi/directional element Pi has the effect of correspondingly/equivalently configuring the directional audio received by the directional audio.

FIG. 5 is an illustration of an example 500 of configuring (e.g., positionally classifying) directional audio from a DM 502 (which represents any of DMs 112) to visually match a view 504 that includes a single centralized head. Relative to view 504, directional beams (B4, B3) and (B1, B2) are on left and right sides of DM 502, respectively, and capture equal or balanced audio originating from the single centralized head (of the active talker). Based on results of head-detecting, controller 114 configures directional audio received by directional beams (B4, B3) and directional audio received by directional beams (B1, B2) as left audio and right audio, respectively. Controller 114 codes the left audio and the right audio into a left audio channel and a right audio channel, respectively, to produce the positional audio channels.

Table 1 below shows example positional designations for each directional beam Bi (and corresponding directional element) of DM 502. Table 1 assumes the DM labeling arrangement shown in FIG. 2.

TABLE 1

| Bi | Positional Designation |
|---|---|
| 1 | R |
| 2 | R |
| 3 | L |
| 4 | L |

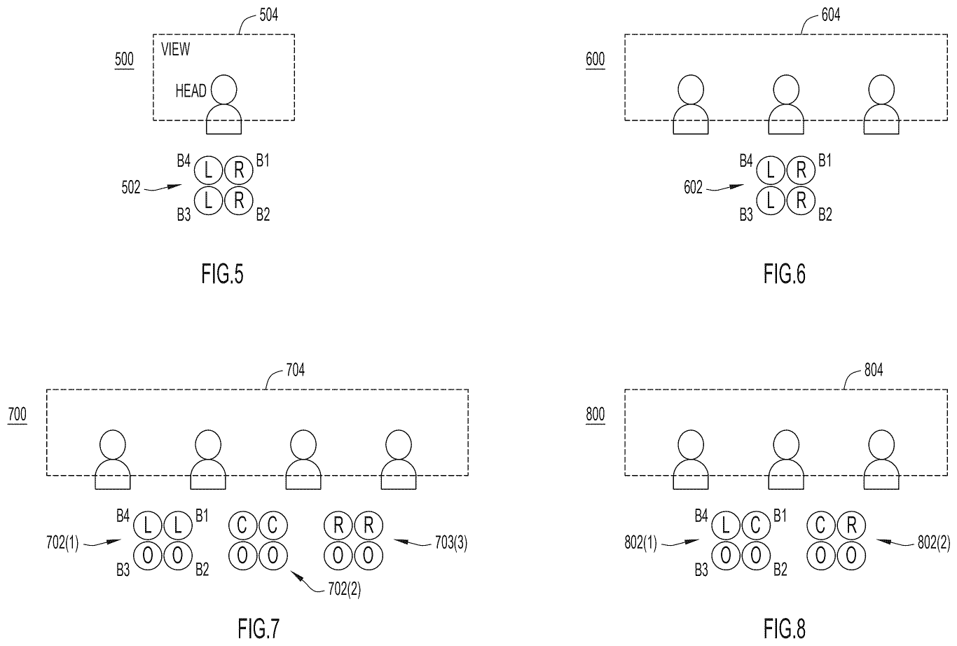

FIG. 6 is an illustration of an example 600 of configuring directional audio from a DM 602 to visually match a view 604 that shows left, center, and right heads spaced-apart across the view. Similar to example 500, based on results of head-detecting, controller 114 configures directional audio received by directional beams (B4, B3) and (B1, B2) as left audio and right audio, respectively.

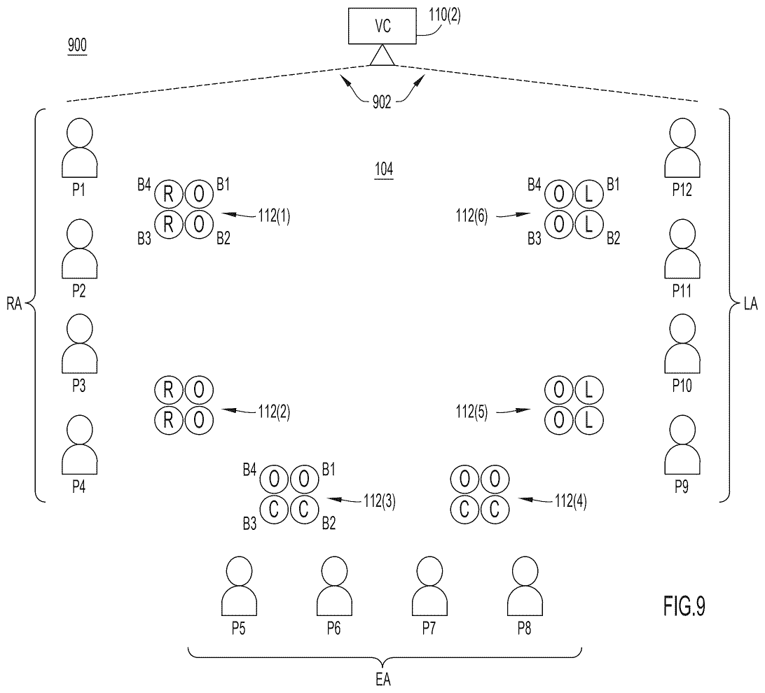

FIG. 7 is an illustration of an example 700 of configuring directional audio received by left, center, and right DMs 702(1), 702(2), and 702(3) to visually match a view 704 that shows four heads spaced-apart across the view from left-to-right. Based on results of head-detecting, controller 114 configures (i) directional audio received by directional beams B4, B1 of DM 702(1) that face the left of view 704 as left audio, (ii) directional audio received by directional beams B4, B1 of DM 702(2) that face the center of view 704 as center audio, and (iii) directional audio received by directional beams B4, B1 of DM 702(3) that face the right of view 704 as right audio. All directional beams that face away from view 704 (e.g., B2, B3) are turned off (i.e., the process includes turning off the aforementioned directional beams). Controller 114 codes the left audio, the center audio, and the right audio into a left audio channel, a center audio channel, and a right audio channel, respectively, to produce positional audio channels.

FIG. 8 is an illustration of an example 800 of configuring directional audio from left and right DMs 802(1) and 802(2) to visually match a view 804 that shows three heads spaced-apart across the view. Based on results of head-detecting, controller 114 configures (i) directional audio received by directional beam B4 of DM 802(1) as left audio, and directional audio received by directional beam B1 of DM 802(1) as center audio, and (ii) directional audio received by directional beam B4 of DM 802(2) as center audio, and directional audio received by directional beam B1 of DM 802(2) as right audio. All directional beams that face away from view 804 (e.g., B2, B3) are turned off. Controller 114 codes the directional audio as in example 700.

In another example in which DMs 802(1) and 802(2) face a view that includes four heads across the view, controller 114 may configure the DMs according to Table 2 below. Table 2 assumes the DM labeling arrangement shown in FIG. 2.

TABLE 2

Positional Designation

| Bi | 802(1) | 802(2) |
|---|---|---|
| B1 | L | R |
| B2 | O | O |
| B3 | O | O |
| B4 | L | R |

FIG. 9 is an illustration of an example 900 of configuring directional audio when a wide-angle view 902 encompasses right area RA, far-end area EA (which is a center area), and left area LA of room 104. FIG. 9 is described also with reference to FIG. 1. Active talkers may be detected in each of the areas. Controller 114 configures (i) directional audio received from directional beams of DMs 112(1) and 112(2) that face right area RA as right audio, (ii) directional audio received from directional beams of DMs 112(3) and 112(4) that face far-end area EA as center audio, and (iii) directional audio received from directional beams of DMs 112(5) and 112(6) that face left area LA as left audio. Table 3 below shows example positional designations for each beam (and corresponding directional element). Table 3 assumes the DM labeling arrangement shown in FIG. 2.

TABLE 3

| | Positional Designation | | |
|---|---|---|---|
| | 112(1) | 112(3) | 112(5) |
| Bi | 112(2) | 112(4) | 112(6) |
| B1 | O | O | L |
| B2 | O | C | L |
| B3 | R | C | O |
| B4 | R | O | O |

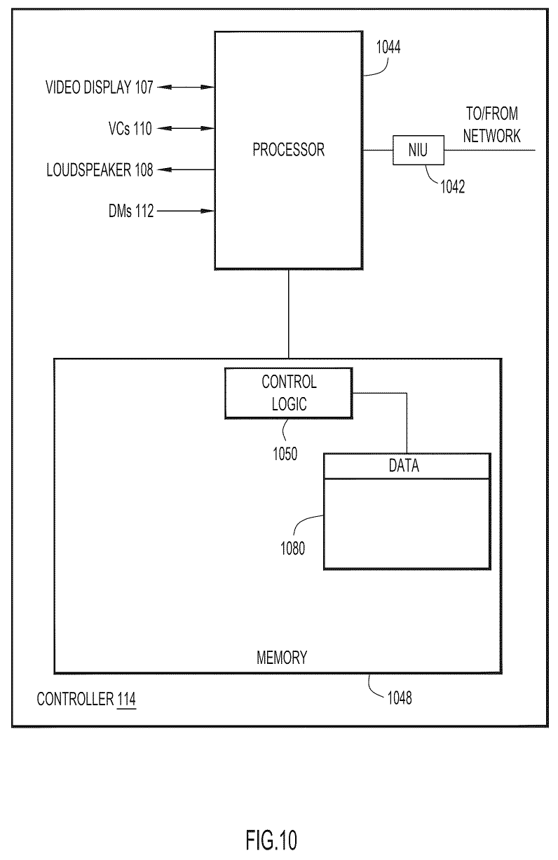

Reference is now made to FIG. 10, which is a block diagram of controller 114 according to an embodiment. There are numerous possible configurations for controller 114 and FIG. 10 is meant to be an example. Controller 114 includes a network interface (I/F) unit (NIU) 1042, a processor 1044, and memory 1048. The aforementioned components of controller 114 may be implemented in hardware, software, firmware, and/or a combination thereof. NIU 1042 is, for example, an Ethernet card or other interface device that allows the controller 114 to communicate over network 308. NIU 1042 may include wired and/or wireless connection capability.

Processor 1044 may include a collection of microcontrollers and/or microprocessors, for example, each configured to execute respective software instructions stored in the memory 1048. The collection of microcontrollers may include, for example: a video controller (not specifically shown) to receive, send, and process video signals related to video display 107 and VCs 110; an audio processor (not specifically shown) to receive, send, and process audio signals related to loudspeaker 108 and DMs 112; and a high-level controller to provide overall control. Portions of memory 1048 (and the instructions therein) may be integrated with processor 1044. In the transmit direction, processor 1044 processes audio/video of participants captured by DMs 112/VCs 110, encodes the captured audio/video into data packets using audio/video codecs, and causes the encoded data packets to be transmitted to network 308. In the receive direction, processor 1044 decodes audio/video from data packets received from network 308 and causes the audio/video to be presented to participants via loudspeaker 108/video display 107. As used herein, the terms “audio” and “sound” are synonymous and used interchangeably. Also, “voice” and “speech” are synonymous and used interchangeably.

The memory 1048 may comprise read only memory (ROM), random access memory (RAM), magnetic disk storage media devices, optical storage media devices, flash memory devices, electrical, optical, or other physical/tangible (e.g., non-transitory) memory storage devices. Thus, in general, the memory 1048 may comprise one or more computer readable storage media (e.g., a memory device) encoded with software comprising computer executable instructions and when the software is executed (by the processor 1044) it is operable to perform the operations described herein. For example, the memory 1048 stores or is encoded with instructions for control logic 1050 perform operations described herein. Control logic 1050 includes logic to process the audio/microphone signals and logic to process captured video. In addition, memory 1048 stores data 1080 used and generated by control logic 1050.

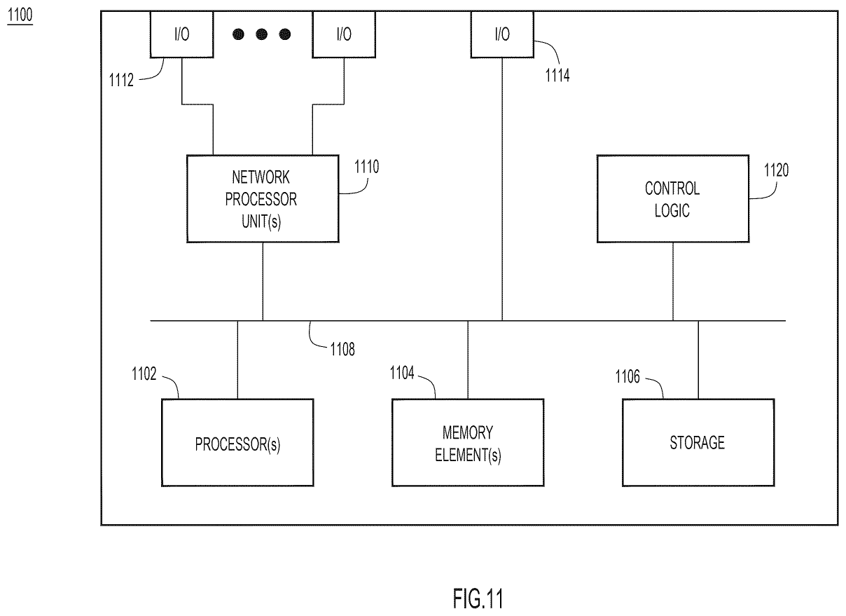

Referring to FIG. 11, FIG. 11 illustrates a hardware block diagram of a computing device 1100 that may perform functions associated with operations discussed herein in connection with the techniques depicted in FIGS. 1-10. In various embodiments, a computing device or apparatus, such as computing device 1100 or any combination of computing devices 1100, may be configured as any entity/entities as discussed for the techniques depicted in connection with FIGS. 1-10 in order to perform operations of the various techniques discussed herein. For example, computing device 1100 may represent conference system 100 and controller 114.

In at least one embodiment, the computing device 1100 may be any apparatus that may include one or more processor(s) 1102, one or more memory element(s) 1104, storage 1106, a bus 1108, one or more network processor unit(s) 1110 interconnected with one or more network input/output (I/O) interface(s) 1112, one or more I/O interface(s) 1114, and control logic 1120. In various embodiments, instructions associated with logic for computing device 1100 can overlap in any manner and are not limited to the specific allocation of instructions and/or operations described herein.

In at least one embodiment, processor(s) 1102 is/are at least one hardware processor configured to execute various tasks, operations and/or functions for computing device 1100 as described herein according to software and/or instructions configured for computing device 1100. Processor(s) 1102 (e.g., a hardware processor) can execute any type of instructions associated with data to achieve the operations detailed herein. In one example, processor(s) 1102 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1104 and/or storage 1106 is/are configured to store data, information, software, and/or instructions associated with computing device 1100, and/or logic configured for memory clement(s) 1104 and/or storage 1106. For example, any logic described herein (e.g., control logic 1120) can, in various embodiments, be stored for computing device 1100 using any combination of memory element(s) 1104 and/or storage 1106. Note that in some embodiments, storage 1106 can be consolidated with memory element(s) 1104 (or vice versa), or can overlap/exist in any other suitable manner.

In at least one embodiment, bus 1108 can be configured as an interface that enables one or more elements of computing device 1100 to communicate in order to exchange information and/or data. Bus 1108 can be implemented with any architecture designed for passing control, data and/or information between processors, memory elements/storage, peripheral devices, and/or any other hardware and/or software components that may be configured for computing device 1100. In at least one embodiment, bus 1108 may be implemented as a fast kernel-hosted interconnect, potentially using shared memory between processes (e.g., logic), which can enable efficient communication paths between the processes.

In various embodiments, network processor unit(s) 1110 may enable communication between computing device 1100 and other systems, entities, etc., via network I/O interface(s) 1112 (wired and/or wireless) to facilitate operations discussed for various embodiments described herein. In various embodiments, network processor unit(s) 1110 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1100 and other systems, entities, etc. to facilitate operations for various embodiments described herein. In various embodiments, network I/O interface(s) 1112 can be configured as one or more Ethernet port(s), Fibre Channel ports, any other I/O port(s), and/or antenna(s)/antenna array(s) now known or hereafter developed. Thus, the network processor unit(s) 1110 and/or network I/O interface(s) 1112 may include suitable interfaces for receiving, transmitting, and/or otherwise communicating data and/or information in a network environment.

I/O interface(s) 1114 allow for input and output of data and/or information with other entities that may be connected to computing device 1100. For example, I/O interface(s) 1114 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 1120 can include instructions that, when executed, cause processor(s) 1102 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1120) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1104 and/or storage 1106 can store data, software, code, instructions (e.g., processor instructions), logic, parameters, combinations thereof, and/or the like used for operations described herein. This includes memory element(s) 1104 and/or storage 1106 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., clement, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

In some aspects, the techniques described herein relate to a method performed by a conference system having video cameras positioned around a room to capture views of areas of the room, the method including: receiving directional audio from directional microphones positioned adjacent to the areas and configured to form directional beams to receive the directional audio from the areas; detecting an active talker in an area based on the directional audio; capturing a view of the area with a video camera; detecting one or more heads across the view; positionally classifying the directional audio received by the directional beams adjacent to the area to visually match the one or more heads in the view to produce positionally classified audio; coding the positionally classified audio into positional audio channels; and transmitting the view and the positional audio channels.

In some aspects, the techniques described herein relate to a method, wherein: detecting the one or more heads detects one of a single centralized head in the view, or heads in a left area and a right area of the view; positionally classifying includes positionally classifying the directional audio as left audio and right audio; and coding includes coding the left audio and the right audio into a left audio channel and a right audio channel, respectively, to produce the positional audio channels.

In some aspects, the techniques described herein relate to a method, wherein: detecting the one or more heads detects heads in a left area, a center area, and a right area of the view; positionally classifying includes positionally classifying the directional audio as left audio, center audio, and right audio to visually match the heads in the left area, the center area, and the right area of the view; and coding includes coding the left audio, the center audio, and the right audio into a left audio channel, a center audio channel, and a right audio channel, respectively, to produce the positional audio channels.

In some aspects, the techniques described herein relate to a method, wherein: positionally classifying includes positionally classifying the directional beams adjacent to the area.

In some aspects, the techniques described herein relate to a method, further including: turning off directional audio not received from the area.

In some aspects, the techniques described herein relate to a method, wherein: one of the video cameras captures a wide-angle view of a left area and a right area of the room; receiving includes receiving the directional audio from the left area and the right area; positionally classifying includes positionally classifying the directional audio received from the left area and the right area as left audio and right audio to visually match the left area and the right area of the wide-angle view, respectively; and coding includes coding the left audio and the right audio into a left audio channel and a right audio channel, respectively, to produce the positional audio channels.

In some aspects, the techniques described herein relate to a method, wherein: the wide-angle view includes a center area of the room; receiving includes receiving the directional audio from the center area; positionally classifying includes positionally classifying the directional audio received from the center area as center audio to visually match the center area of the wide-angle view; and coding includes coding the center audio into a center audio channel, to produce the positional audio channels.

In some aspects, the techniques described herein relate to a method, further including: participating in an online conference with a remote endpoint device over a network, wherein transmitting includes transmitting the view and the positional audio channels to the remote endpoint device over the network.

In some aspects, the techniques described herein relate to a method, wherein: each directional microphone forms the directional beams as spaced-apart directional beams.

In some aspects, the techniques described herein relate to a method, further including: upon determining that an orientation of a head of the active talker in the view is facing the video camera, switching the view to an active view for transmission.

In some aspects, the techniques described herein relate to an apparatus including: video cameras to be positioned around a room to capture views of areas of the room; directional microphones configured to be positioned adjacent to the areas and form directional beams that receive directional audio from the areas; and a controller coupled to the video cameras and the directional microphones and configured to perform: detecting an active talker in an arca based on the directional audio; receiving a view of the area captured by a video camera; detecting one or more heads across the view; positionally classifying the directional audio received by the directional beams adjacent to the area to visually match the one or more heads in the view to produce positionally classified audio; coding the positionally classified audio into positional audio channels; and transmitting the view and the positional audio channels.

In some aspects, the techniques described herein relate to an apparatus, wherein the controller in configured to perform: detecting the one or more heads by detecting one of a single centralized head in the view, or heads in a left area and a right area of the view; positionally classifying by positionally classifying the directional audio as left audio and right audio; and coding by coding the left audio and the right audio into a left audio channel and a right audio channel, respectively, to produce the positional audio channels.

In some aspects, the techniques described herein relate to an apparatus, wherein the controller in configured to perform: detecting the one or more heads by detecting heads in a left area, a center area, and a right area of the view; positionally classifying by positionally classifying the directional audio as left audio, center audio, and right audio to visually match the heads in the left area, the center area, and the right area of the view; and coding by coding the left audio, the center audio, and the right audio into a left audio channel, a center audio channel, and a right audio channel, respectively, to produce the positional audio channels.

In some aspects, the techniques described herein relate to an apparatus, wherein: the controller in configured to perform positionally classifying by positionally classifying the directional beams adjacent to the area.

In some aspects, the techniques described herein relate to an apparatus, wherein the controller is configured to perform, when one of the video cameras captures a wide-angle view of a left area and a right area of the room: receiving by receiving the directional audio from the left area and the right area; positionally classifying by positionally classifying the directional audio received from the left area and the right area as left audio and right audio to visually match the left area and the right area of the wide-angle view, respectively; and coding by coding the left audio and the right audio into a left audio channel and a right audio channel, respectively, to produce the positional audio channels.

In some aspects, the techniques described herein relate to an apparatus, wherein the controller is configured to perform, when the wide-angle view further includes a center area of the room: receiving by receiving the directional audio from the center area; positionally classifying by positionally classifying the directional audio received from the center area as center audio to visually match the center area of the wide-angle view; and coding by coding the center audio into a center audio channel, to produce the positional audio channels.

In some aspects, the techniques described herein relate to an apparatus, wherein the controller is further configured to perform: participating in an online conference with a remote endpoint device over a network, wherein the controller is configured to perform transmitting by transmitting the view and the positional audio channels to the remote endpoint device over the network.

In some aspects, the techniques described herein relate to a non-transitory computer readable medium encoded with instructions that, when executed by a processor of a conference system having video cameras positioned around a room to capture views of areas of the room, cause the processor to perform: receiving directional audio from directional microphones positioned adjacent to the areas and configured to form directional beams to receive the directional audio from the areas; detecting an active talker in an area of the areas based on the directional audio; capturing a view of the area with a video camera; detecting one or more heads across the view; positionally classifying the directional audio received by the directional beams adjacent to the area to visually match the one or more heads in the view to produce positionally classified audio; coding the positionally classified audio into positional audio channels; and transmitting the view and the positional audio channels.

In some aspects, the techniques described herein relate to a non-transitory computer readable medium, wherein the instructions include instructions that cause the processor to perform: detecting one or more heads by detecting one of a single centralized head in the view, or heads in a left area and a right area of the view; positionally classifying by positionally classifying the directional audio as left audio and right audio; and coding by coding the left audio and the right audio into a left audio channel and a right audio channel, respectively, to produce the positional audio channels.

In some aspects, the techniques described herein relate to a non-transitory computer readable medium, wherein the instructions include instructions that cause the processor to perform: detecting one or more heads by detecting heads in a left area, a center area, and a right area of the view; positionally classifying configuring the directional audio as left audio, center audio, and right audio to visually match the heads in the left area, the center area, and the right area of the view; and coding includes coding the left audio, the center audio, and the right audio into a left audio channel, a center audio channel, and a right audio channel, respectively, to produce the positional audio channels.

The above description is intended by way of example only. Various modifications and structural changes may be made therein without departing from the scope of the concepts described herein and within the scope and range of equivalents of the claims.

What is claimed is:

1. A method performed by a conference system having video cameras positioned around a room to capture views of areas of the room, the method comprising:
receiving directional audio from directional microphones positioned adjacent to the areas and configured to form directional beams to receive the directional audio from the areas;
detecting an active talker in an area based on the directional audio;
capturing a view of the area with a video camera;
detecting one or more heads across the view;
positionally classifying the directional audio received by the directional beams adjacent to the area to visually match the one or more heads in the view to produce positionally classified audio;
coding the positionally classified audio into positional audio channels; and
transmitting the view and the positional audio channels.

2. The method of claim 1, wherein:
detecting the one or more heads detects one of a single centralized head in the view, or heads in a left area and a right area of the view;
positionally classifying includes positionally classifying the directional audio as left audio and right audio; and
coding includes coding the left audio and the right audio into a left audio channel and a right audio channel, respectively, to produce the positional audio channels.

3. The method of claim 1, wherein:
detecting the one or more heads detects heads in a left area, a center area, and a right area of the view;
positionally classifying includes positionally classifying the directional audio as left audio, center audio, and right audio to visually match the heads in the left area, the center area, and the right area of the view; and
coding includes coding the left audio, the center audio, and the right audio into a left audio channel, a center audio channel, and a right audio channel, respectively, to produce the positional audio channels.

4. The method of claim 1, wherein:
positionally classifying includes positionally classifying the directional beams adjacent to the area.

5. The method of claim 1, further comprising:
turning off directional audio not received from the area.

6. The method of claim 1, wherein:
one of the video cameras captures a wide-angle view of a left area and a right area of the room;
receiving includes receiving the directional audio from the left area and the right area;
positionally classifying includes positionally classifying the directional audio received from the left area and the right area as left audio and right audio to visually match the left area and the right area of the wide-angle view, respectively; and
coding includes coding the left audio and the right audio into a left audio channel and a right audio channel, respectively, to produce the positional audio channels.

7. The method of claim 6, wherein:
the wide-angle view includes a center area of the room;
receiving includes receiving the directional audio from the center area;
positionally classifying includes positionally classifying the directional audio received from the center area as center audio to visually match the center area of the wide-angle view; and
coding includes coding the center audio into a center audio channel, to produce the positional audio channels.

8. The method of claim 1, further comprising:
participating in an online conference with a remote endpoint device over a network,
wherein transmitting includes transmitting the view and the positional audio channels to the remote endpoint device over the network.

9. The method of claim 1, wherein:
each directional microphone forms the directional beams as spaced-apart directional beams.

10. The method of claim 1, further comprising:
upon determining that an orientation of a head of the active talker in the view is facing the video camera, switching the view to an active view for transmission.

11. An apparatus comprising:
video cameras to be positioned around a room to capture views of areas of the room;
directional microphones configured to be positioned adjacent to the areas and form directional beams that receive directional audio from the areas; and
a controller coupled to the video cameras and the directional microphones and configured to perform:
detecting an active talker in an area based on the directional audio;
receiving a view of the area captured by a video camera;
detecting one or more heads across the view;
positionally classifying the directional audio received by the directional beams adjacent to the area to visually match the one or more heads in the view to produce positionally classified audio;
coding the positionally classified audio into positional audio channels; and
transmitting the view and the positional audio channels.

12. The apparatus of claim 11, wherein the controller in configured to perform:
detecting the one or more heads by detecting one of a single centralized head in the view, or heads in a left area and a right area of the view;
positionally classifying by positionally classifying the directional audio as left audio and right audio; and
coding by coding the left audio and the right audio into a left audio channel and a right audio channel, respectively, to produce the positional audio channels.

13. The apparatus of claim 11, wherein the controller in configured to perform:
detecting the one or more heads by detecting heads in a left area, a center area, and a right area of the view;
positionally classifying by positionally classifying the directional audio as left audio, center audio, and right audio to visually match the heads in the left area, the center area, and the right area of the view; and
coding by coding the left audio, the center audio, and the right audio into a left audio channel, a center audio channel, and a right audio channel, respectively, to produce the positional audio channels.

14. The apparatus of claim 11, wherein:
the controller in configured to perform positionally classifying by positionally classifying the directional beams adjacent to the area.

15. The apparatus of claim 11, wherein the controller is configured to perform, when one of the video cameras captures a wide-angle view of a left area and a right area of the room:
receiving by receiving the directional audio from the left area and the right area;
positionally classifying by positionally classifying the directional audio received from the left area and the right area as left audio and right audio to visually match the left area and the right area of the wide-angle view, respectively; and
coding by coding the left audio and the right audio into a left audio channel and a right audio channel, respectively, to produce the positional audio channels.

16. The apparatus of claim 15, wherein the controller is configured to perform, when the wide-angle view further includes a center area of the room:
receiving by receiving the directional audio from the center area;
positionally classifying by positionally classifying the directional audio received from the center area as center audio to visually match the center area of the wide-angle view; and
coding by coding the center audio into a center audio channel, to produce the positional audio channels.

17. The apparatus of claim 11, wherein the controller is further configured to perform:
participating in an online conference with a remote endpoint device over a network,
wherein the controller is configured to perform transmitting by transmitting the view and the positional audio channels to the remote endpoint device over the network.

18. A non-transitory computer readable medium encoded with instructions that, when executed by a processor of a conference system having video cameras positioned around a room to capture views of areas of the room, cause the processor to perform:
receiving directional audio from directional microphones positioned adjacent to the areas and configured to form directional beams to receive the directional audio from the areas;
detecting an active talker in an area of the areas based on the directional audio;
capturing a view of the area with a video camera;
detecting one or more heads across the view;
positionally classifying the directional audio received by the directional beams adjacent to the area to visually match the one or more heads in the view to produce positionally classified audio;
coding the positionally classified audio into positional audio channels; and
transmitting the view and the positional audio channels.

19. The non-transitory computer readable medium of claim 18, wherein the instructions include instructions that cause the processor to perform:
detecting one or more heads by detecting one of a single centralized head in the view, or heads in a left area and a right area of the view;
positionally classifying by positionally classifying the directional audio as left audio and right audio; and
coding by coding the left audio and the right audio into a left audio channel and a right audio channel, respectively, to produce the positional audio channels.

20. The non-transitory computer readable medium of claim 18, wherein the instructions include instructions that cause the processor to perform:
detecting one or more heads by detecting heads in a left area, a center area, and a right area of the view;
positionally classifying configuring the directional audio as left audio, center audio, and right audio to visually match the heads in the left area, the center area, and the right area of the view; and
coding includes coding the left audio, the center audio, and the right audio into a left audio channel, a center audio channel, and a right audio channel, respectively, to produce the positional audio channels.
